(19) United States
(12) Patent Application Publication
(10) Pub. No.: US 2009/0231440 A1
(43) Pub. Date: Sep. 17, 2009

(54) Brightness automatically adjusting system and method for adjusting brightness thereof

(75) Inventors: Jing-Zhou Lai, Shenzhen (CN); Zou-Qiu Chen, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignees: INNOCOM TECHNOLOGY (SHENZHEN) CO., LTD.; INNOLUX DISPLAY CORP.

(21) Appl. No.: 12/381,796

(22) Filed: Mar. 16, 2009

(30) Foreign Application Priority Data
Mar. 14, 2008 (TW) 97109154

(51) Int. Cl. H04N 5/225; G09G 3/36; G06K 9/46

(52) U.S. Cl. 348/207.1; 345/102; 382/195; 348/E05.024

(57) ABSTRACT

A brightness adjustment system includes a camera, a computer, and a liquid crystal display. The liquid crystal display includes a signal processor, a backlight control circuit and a backlight unit. The camera captures environmental images and sends the environmental image to the computer. The computer analyzes the environmental image to obtain a environmental brightness and sends a control signal to the signal processor according to the environmental brightness. The signal processor receives the control signal and sends an adjusting signal to the backlight unit according to the control signal. The backlight control circuit adjusts a brightness of the backlight unit according to the adjusting signal. A method of automatically adjusting brightness of a liquid crystal display is also provided.

### FIELD OF THE DISCLOSURE

The present disclosure relates to a brightness adjustment system and a brightness adjustment method of a liquid crystal display.

### GENERAL BACKGROUND

Liquid crystal display devices are capable of displaying clear and sharp images via thousands or even millions of pixels that make up the complete image.

Liquid crystals in the liquid crystal display do not themselves emit light, and require a light source to display data. Backlight modules applied with the liquid crystal display often provide the required light. Power consumption of the backlight module, however, makes up a large part of the overall power consumption of the unit. Automatic adjustment of brightness of the liquid crystal display can decrease electric power consumption.

However, a typical automatic backlight adjustment method requires a light sensor to detect environmental brightness and a related control circuit to calculate the environmental brightness, a costly solution.

It is desirable to provide a brightness adjustment system and method which can overcome the described limitations.

### BRIEF DESCRIPTION OF THE DRAWINGS

FIG. 1 is a block diagram of a brightness adjustment system for a liquid crystal display according to the present disclosure, including a web camera, a computer, and a signal processor.

FIG. 2 is an environmental image captured by the web camera of FIG. 1.

FIG. 3 is a flowchart of a method of a computer providing a brightness adjustment parameter for a liquid crystal display.

FIG. 4 is a flowchart of a method of a signal processor processing the brightness adjustment parameter of FIG. 3.

### DETAILED DESCRIPTION OF THE DISCLOSURE

Reference will now be made to the drawings to describe various inventive embodiments of the present disclosure in detail, wherein like numerals refer to like elements throughout.

FIG. 1 is a block diagram of a brightness adjustment system for a liquid crystal display according to the present disclosure, including a web camera 100, a computer 101, and a liquid crystal display 10. The liquid crystal display 10 includes a signal processor 102, a backlight control circuit 103, and a backlight unit 104. The web camera 100 is electrically connected to the computer 101 via a universal serial bus (USB) interface and captures environmental images in real time. The computer 101 receives and analyzes the environmental image from the web camera 100 for generating a brightness adjustment command and a brightness adjustment parameter, and sends the brightness adjustment command and the brightness adjustment parameter to the signal processor 102. The signal processor 102 adjusts the brightness of the backlight unit 104 according to the brightness adjustment command and the brightness adjustment parameter via the backlight control circuit 103, thereby controlling the brightness of the liquid crystal display 10. The backlight unit 104, can, for example, be a cold cathode decoration lamp (CCFL) or a light emitting diode (LED).

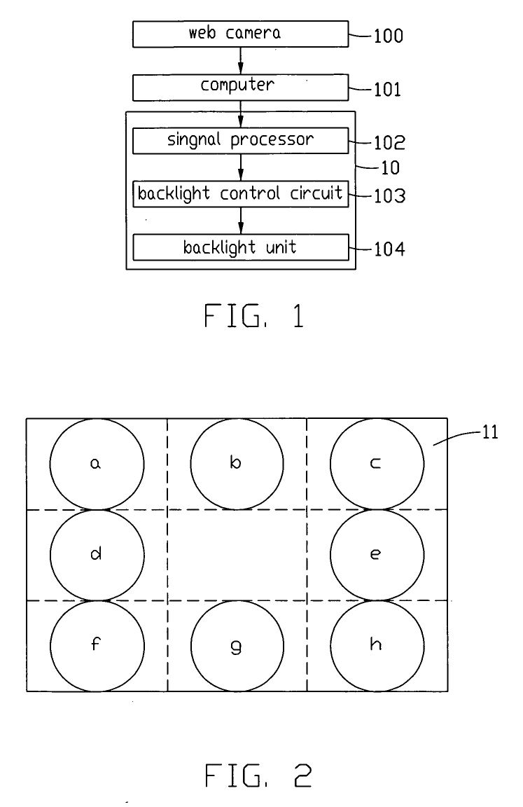

Referring to FIG. 2, an environmental image 11 captured by the web camera 100 of FIG. 1 is shown. Because the computer 101 requires considerable memory resources to analyze the environmental image 11, execution of the following steps can acquire an accurate environmental brightness measurement utilizing minimum memory resources, and generate calculation results without undue influence by calculation processing.

In Step 1, the environmental image 11 is divided into a 3×3 rectangular matrix, resulting in nine rectangles, each having the same area.

In Step 2, a number of circles a, b . . . , h are defined within eight rectangles leaving the center rectangle unoccupied. A center of each rectangle is defined as a corresponding center of each circle, and half length of a short side of each rectangle is defined as a corresponding radius of each circle. The three circles in the first row of the rectangle matrix are respectively denoted as a, b, and c. The two opposite circles in the second row of the rectangle matrix are respectively denoted as d and e. The three circles in the third row of the rectangle matrix are respectively denoted as f, g, and h. Because the central part of the environmental image 11 is often a focus of the image, generating little environmental brightness, the central part of the environmental image 11 represented by the rectangle in the center of the environmental image 11 is ignored. Circles a, b . . . , h are tasked with analyzing the environmental brightness to eliminate the influence liquid crystal display 10 rotation.

In Step 3, a low pass filter (not shown) is employed to filter off high frequency parts of the environmental image 11 within the eight circles a, b . . . , h, in other words, to filter off detailed parts of the environmental image 11 within the eight circles a, b . . . , h. Because the detailed parts of the environmental image 11 have insufficient information regarding environmental brightness, the detailed parts of the environmental image 11 are filtered off to reduce influence on later processing.

A histogram and brightness Hi (i=a, b, c . . . h) in each circle a, b . . . , h is calculated according to:

Hi=(pixel value×a histogram value of pixel)/pixel number in circle, wherein the pixel value is in a range of 0-255.

An average brightness of all the eight circles a, b . . . , h is defined as the environmental brightness.

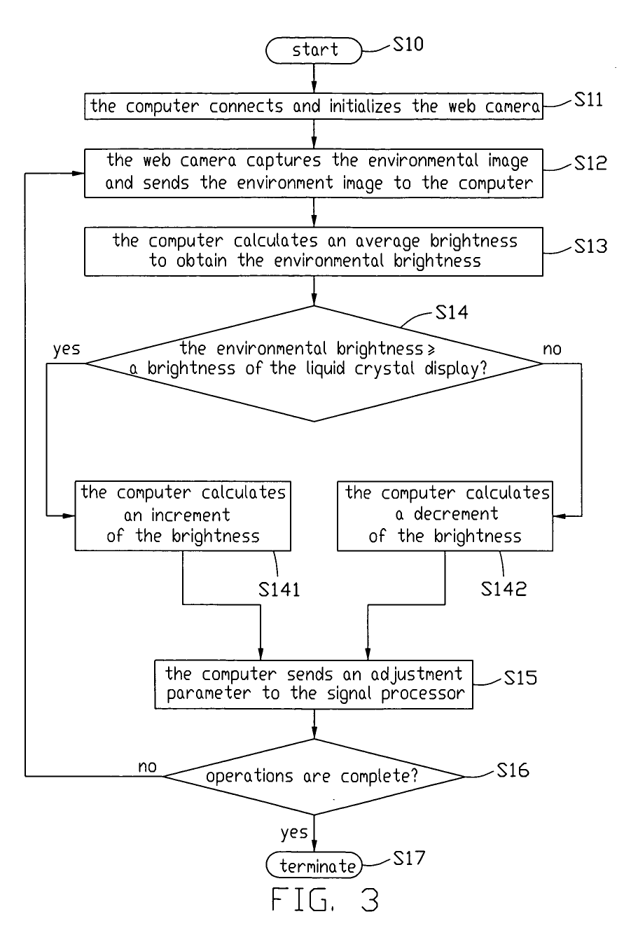

Referring to FIG. 3, a flowchart of a method for the computer 101 providing a brightness adjustment parameter to the liquid crystal display is shown. The method includes the following steps.

In Step S10, the method is implemented.

In Step S11, the computer 101 connects and initializes the web camera 100.

In Step S12, the web camera 100 captures the environmental image 11 and sends the environmental image 11 to the computer 101.

In Step S13, the computer 101 calculates an average brightness in the eight circles a, b . . . , h to obtain the environmental brightness.

In Step S14, the computer 101 determines whether the environmental brightness exceeds or equals a brightness of the liquid crystal display 10. If so, Step S141 is executed. If not, step S142 is executed.

In Step S141, the computer 101 calculates an increment of the brightness.

In Step S142, the computer 101 calculates a decrement of the brightness.

In Step S15, the computer 101 sends an adjustment parameter to the signal processor 102.

In Step S16, it is determined whether operations are complete. If so, Step S17 is executed. If not, Step S12 is executed.

In Step S17, the operation is terminated.

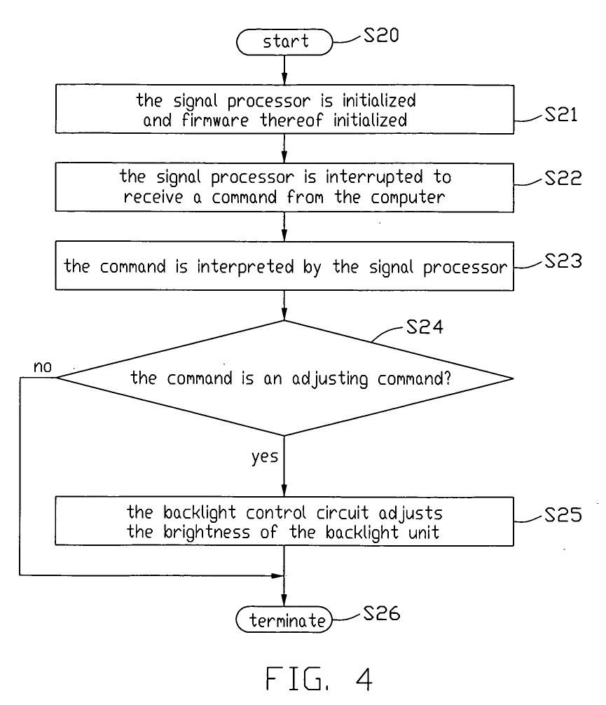

Referring to FIG. 4, a flowchart of a method of the signal processor 102 processing the brightness adjustment parameters is shown. The method includes the following steps.

In Step S20, the method is implemented.

In Step S21, the signal processor 102 is initialized and firmware thereof initialized.

In Step S221, the signal processor 102 is interrupted to receive a command from the computer 101.

In Step S23, the command is interpreted by the signal processor 102.

In Step S24, the signal processor 102 ascertains whether the command is an adjustment command. If so, Step S25 is executed. If not, Step S26 is executed, in which a look up table in the firmware storing a number of adjustment commands is consulted. The signal processor 102 determines whether the received command matches any of the stored adjustment commands. If so, Step S25 is executed. If not, Step S26 is executed.

In Step S25, backlight control circuit 103 adjusts the brightness of the backlight unit 104.

In Step S26, the operation is terminated.

The brightness adjustment system of liquid crystal display 10 of the disclosure employs web camera 100 to capture an environmental image 11 in real time. The computer 101 analyzes the received environmental image 11 to obtain the environmental brightness, which it then compares with a brightness of the liquid crystal display 10, utilizing the result to determine whether signal processor 102 needs adjust brightness of the liquid crystal display 10. When the environmental brightness is less than the brightness of the liquid crystal display 10, the brightness of the liquid crystal display 10 is decreased to equal the environmental brightness. When the environmental brightness exceeds the brightness of the liquid crystal display, the brightness of the liquid crystal display is increased to equal the environmental brightness.

The web camera 100 is low in cost and requires no complicated control circuitry to obtain the environmental image, thus the cost of the brightness adjustment system is reduced. Furthermore, the environmental brightness is calculated according to the environmental image 11 captured by the web camera 100, avoiding information errors when environmental brightness is detected by a light sensor.

The high frequency parts of the environmental image 11 are filtered off to calculate the environmental brightness, such that computer 101 requires only minimal memory resources when the environmental image 11 is analyzed.

Because an average brightness in eight circles a, b . . . , h of the environmental image 11 is defined as the environmental brightness, and the signal processor 102 can direct the backlight control circuit 103 to adjust the brightness of the backlight unit 104 according to an adjustment parameter obtained by comparing the environmental brightness and the brightness of the liquid crystal display 10, brightness adjustment is accomplished in real time.

Alternatively, the web camera 100 can be replaced by other types of image capturing device such as a digital camera. The web camera 100 can also be positioned inside the liquid crystal display 10.

It is to be understood, however, that even though numerous characteristics and advantages of certain inventive embodiments have been set out in the foregoing description, together with details of the structures and functions of the embodiments, the disclosure is illustrative only; and that changes may be made in detail, especially in matters of arrangement of parts within the principles of present invention to the full extent indicated by the broad general meaning of the terms in which the appended claims are expressed.

What is claimed is:

1. A brightness adjustment system comprising:
a camera;
a computer; and
a liquid crystal display comprising a signal processor, a backlight control circuit, and a backlight unit,
wherein the camera captures an environmental image and sends the environmental image to the computer, the computer analyzes the environmental image to obtain a environmental brightness and sends a control signal to the signal processor according to the environmental brightness, the signal processor receives the control signal and sends an adjusting signal to the backlight unit according to the control signal, and the backlight control circuit adjusts a brightness of the backlight unit according to the adjusting signal.

2. The brightness adjustment system of claim 1, wherein the camera is connected to the computer via a universal serial bus (USB) interface.

3. The brightness adjustment system of claim 1, wherein the camera is positioned inside the liquid crystal display.

4. The brightness adjustment system of claim 1, wherein a look up table in firmware of the signal processor stores a number of adjustment commands, and the signal processor compares a received command from the computer with the look up table to judge if the received command is valid.

5. The brightness adjustment system of claim 1, wherein the computer defines several areas on the environmental image and respectively analyzes the several areas of the environmental image to obtain a brightness information of the environmental image.

6. The brightness adjustment system of claim 5, wherein the several areas are circular areas, the computer calculates an average brightness of the several circular areas and defines the average brightness as the environmental brightness.

7. The brightness adjustment system of claim 6, wherein the computer calculates a difference between the environmental brightness and a brightness of the liquid crystal display.

8. The brightness adjustment system of claim 7, wherein the signal processor adjusts the brightness of the backlight unit according to the difference between the environmental brightness and a brightness of the liquid crystal display.

9. The brightness adjustment system of claim 1, wherein the backlight unit is a cold cathode decoration lamp (CCFL) or a light emitting diode (LED).

10. A method of automatically adjusting brightness of a liquid crystal display comprising:
capturing an environmental image;
analyzing the environmental image to obtain environmental brightness;
obtaining a brightness of the liquid crystal display;
comparing the environmental brightness with the brightness of the liquid crystal display and generating a control signal according to a comparison result;
generating an adjusting signal according to the control signal; and
adjusting the brightness of the liquid crystal display according to the adjusting signal.

11. The method of claim 10, wherein the environmental image is captured by a web camera or a digital camera.

12. The method of claim 11, wherein the camera has a universal serial bus interface.

13. The method of claim 11, wherein the camera is positioned inside the liquid crystal display.

14. The method of claim 11, wherein several areas are defined on the environmental image for obtaining the environmental brightness.

15. The method of claim 14, wherein the several areas are circular areas, and an average brightness of the several circular areas is calculated and defined as the environmental brightness.

16. The method of claim 11, wherein the comparison result is a difference of the environmental brightness and the brightness of the liquid crystal display.

17. The method of claim 16, wherein when the environmental brightness exceeds that of the liquid crystal display, the brightness of the liquid crystal display is increased to equal the environmental brightness.

18. The method of claim 16, wherein when the environmental brightness is less than the brightness of the liquid crystal display, the brightness of the liquid crystal display is decreased to equal the environmental brightness.

19. The method of claim 11, further comprising determination of whether the adjusting signal is valid.

20. The method of claim 19, wherein a look up table is used to judge whether the adjusting signal is valid.
